(19) United States
(12) Patent Application Publication
(10) Pub. No.: US 2011/0257052 A1
(43) Pub. Date: Oct. 20, 2011

(54) Method for Practicing Microbial Enhanced Oil Recovery Using Nitrogen Containing Fertilizers Recovered from Contaminated Water for Feeding Microbes

(76) Inventor: Gerald J. GROTT, Phoenix, AZ (US)

(21) Appl. No.: 13/087,214

(22) Filed: Apr. 14, 2011

Related U.S. Application Data
(60) Provisional application No. 61/324,227, filed on Apr. 14, 2010.

(51) Int. Cl. C09K 8/84

(52) U.S. Cl. 507/269

(57) ABSTRACT

A method of using nitrates, nitrites, or ammonium recovered from contaminated water for feeding microbes used in microbial enhanced oil recovery (MEOR). If required, the nitrogen waste removed from contaminated waters is treated to be converted as nitrates or nitrites. The nitrates and nitrites are mixed with microbes that are then injected into oil wells for improved tertiary oil production or injected separately depending on balance of feed and microbes in well brine as judged from examining brine that exits well with the oil. The use of nitrates recovered from contaminated waters to feed microbes in MEOR is cost effective for both the process of water decontamination and oil recovery.

The current application claims a priority to the U.S. Provisional Patent application Ser. No. 61/324,227 filed on Apr. 14, 2010.

### FIELD OF THE INVENTION

The present invention relates generally to a method of using nitrates recovered from contaminated water for feeding microbes. More specifically, the present invention is an efficient and low-cost method of using nitrates recovered from contaminated water for feeding microbes that can be used for applications including microbial enhanced oil recovery.

### BACKGROUND OF THE INVENTION

Nitrogen is an essential element in many processes and in life. Nitrogen is used in amino acids, proteins, and is also present in DNA. Large amounts of nitrogen in the form of ammonium, nitrites, and or nitrates contaminate bodies of water due to natural and unnatural sources. However, the concentration of nitrogen contamination is increasing rapidly due to the human influenced on the natural nitrogen cycle. Natural occurring nitrogen originates from decomposition of animals and plants, natural phenomena including lighting, or animal waste. In a natural nitrogen cycle, such sources of nitrogen are absorbed into the soil and denitrified by existing microbes which feed on nitrogen. However, due to human influence through the agricultural fertilization, biomass burning, sewage, and other industrial sources, the nitrogen is accumulated in large concentrations and introduced into the nitrogen cycle. With limited amount of microbes, the large concentrated amount of nitrogen waste is not completely denitrified by the microbial activity. This allows the nitrogen waste introduced back into the nitrogen cycle to flow into water bodies. For example, sewage facilities with septic tank, collect and hold large amounts of nitrogen. The collected nitrogen is disposed of by being discharged into a drain field in the ground. The microbial activity in the soil of the drain field consumes the nitrogen and other contaminant from the septic tank waste. However, when the amount of nitrogen and contaminants from the waste is overwhelming, the microbial activity is unable to handle the all of the contaminants. The waste bypasses the microbes and enters a body of water which may be a drinking water source. The nitrogen waste that bypasses the microbes enters and contaminates drinking water. As a result humans drinking the water are placed at risk of poisoning. Another example of nitrogen waste sources from agricultural fertilizing. When crop plants are over fertilized, the plants are unable to utilize all of the nitrogen containing fertilizer. The unused nutrients from the fertilizer are left in the soil and seeps into ground water. In some cases, rain washes off the unused nitrogen and allows the nitrogen waste to flow into water bodies such as streams and rivers.

To ensure that the drinking water is safe for human consumption, water obtained from drinking water sources are processed and filtered of the contaminants. Although nitrates and nitrites are used in human bodies are metabolized for amino acids and protein, when consumed at high levels, the highly reactive nitrogen contaminants such as nitrates and nitrites are toxic for humans. At lower levels of concentration, humans digest and convert nitrates to nitrites, which in turn are used in for creating amino acids. In adults, this conversion occurs in saliva. However, in infants, the conversion of nitrates to nitrites occurs in the gastrointestinal track. Infants convert nitrates to nitrate at a rate double of adults. At high levels inside a human body, the nitrates and nitrites are able to enter the bloodstream. Inside the bloodstream, the nitrogen contaminants are able to react with hemoglobin. Hemoglobin is an important protein in blood cells that carries oxygen from the lung to all of the body parts and carbon dioxide from all of the body parts to the lung for exchange. When the nitrites enter the bloodstream, they react with the hemoglobin by oxidizing the iron atoms on the hemoglobin. The oxidation of the iron atoms prevents hemoglobin from being able to carry oxygen. With the accumulation of nitrates in the bloodstream, more and more hemoglobin is rendered unable to receive oxygen from the lungs. The lack of oxygen being supplied to the human's organs causes the human to suffocate.

Nitrates are undetectable by color, taste, or smell in the concentrations mixed with water. This is why it is important for water treatment facilities to filter the contaminants from drinking water. To prevent nitrogen waste poisoning, water treatment plants filtrate the drinking water to remove contaminants including nitrates, sulfates, chlorides, or bicarbonates. Traditional methods of removing contaminants from water include ion exchanges. Ion exchanges are able to filter the contaminants and separate it from the drinking water. The nitrogen waste is separated from the drinking water into a water contaminant brine.

The present invention proposes the method of using the nitrogen extracted from contaminated water for use as nutrients to microbes in microbial enhanced oil recover (MEOR). Unlike the common microbe that exists in soil, the microbes used in MEOR are unique microbes that function by partially digesting hydrocarbon molecules through the generation of biosurfactants. The microbes used are generally unique microbes that are discovered or developed by means of gene mutation. However, to nurture the microbes, nutrients are injected into the oil formation. The nutrients allow the microbes to increase production of natural surfactants that metabolizes the crude oil underground. By using the nitrogen contaminant extracted from the contaminated water, the present invention is able to clean existing water for safe drinking, reduce contamination of other waters through mixing, and reduce air contamination. Additionally, the extraction of nitrates and nitrites from contaminated water offer a cheap option for providing nutrients to microbes used in MEOR.

### BRIEF DESCRIPTION OF THE DRAWINGS

FIG. 1 is a flow chart of the preferred method of the present invention where a high concentration of nitrates and nitrites are removed from contaminated water by means of anion exchange.

FIG. 2 is a flow chart of the method of the present invention where ammonium is recovered by means of cation exchange.

### DETAIL DESCRIPTIONS OF THE INVENTION

All illustrations of the drawings are for the purpose of describing selected versions of the present invention and are not intended to limit the scope of the present invention.

The present invention is the method of using nitrates and nitrites recovered from contaminated water for feeding microbes used in Microbial Enhanced Oil Recovery (MEOR). The present invention utilizes the large amounts of nitrogen waste extracted from contaminated waters in the form of ammonium, nitrites, and nitrates for the application of MEOR. Contaminated waters are generally treated and filtered in water treatment plants to ensure cleanliness and safety for drinking.

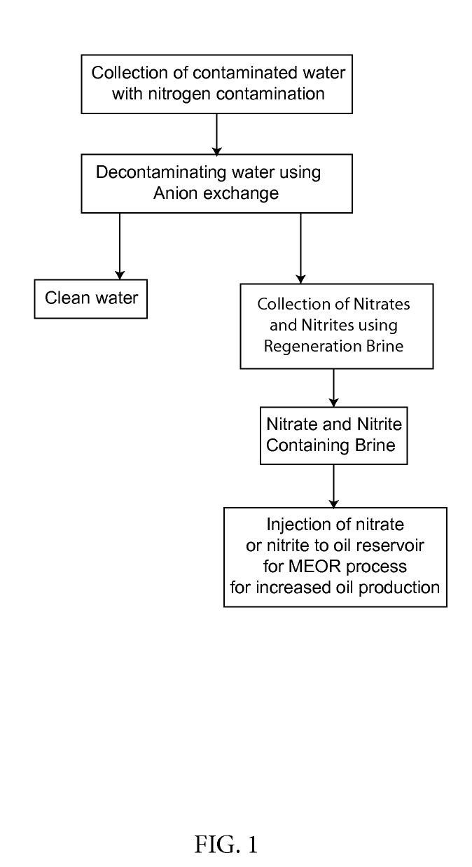

In reference to FIG. 1, to remove the contaminants such as nitrates from the contaminated water, water treatment facilities traditionally use the method of ion exchange. Ion exchange water treatments utilize a bed of ion media to attract and retain the contaminants inside water. The ion resins are insoluble polymer matrixes formed into small beads. The ion resins have a highly developed structure with a plurality of pores on its surface. The pores of the ion resins are sites that are able to easily trap and release ions. The contaminated waters are coursed through a bed of ion resins while the ion resins attract and retain the contaminants from the passing water. The contaminants are attracted and retained by the ion resins while the ion resins release salt in exchanges for the contaminant. There are two types of standard anion resins that are used to filter out water contaminants. The first type is a resin with ion exchange capabilities derived from a trimethylamine group. The second type of standard anion resin is a resin with a dimethylethanolamine group. These standard anion resins have affinities for the contaminants including sulfate, nitrates, chlorides and bicarbonates. However, these standard anion resins have affinity to other contaminants in relation to nitrate. As a result, the brine obtained from the ion exchange process using the standard anion resins will have concentrations of substances other than nitrates. To obtain brine with a strong concentration of nitrates with lower concentrations of other types of contaminants, nitrate selective resins are used. Nitrate selective resins are able to strongly retain nitrates more than other ions. The nitrate selective resins include functional groups that are placed into the anion exchange media that increases the nitrate affinity. The functional groups included in the nitrate selective anion exchange media makes it difficult for ions other than nitrates to attach themselves to the resin. The anion exchange media with the retained nitrates are treated with regeneration brine. The regeneration brine is generally a sodium chloride brine, but other chloride brines may be used. The sodium chloride brine removes the nitrates from the anion exchange media by means of the sodium chloride exchanging positioned with the nitrates on the resins. The sodium chloride brine is then partially transformed into a nitrate brine. As a result, contaminated water treated with the nitrate selective produces brine with higher concentrations of nitrates that can be used as nutrients for microbes in MEOR.

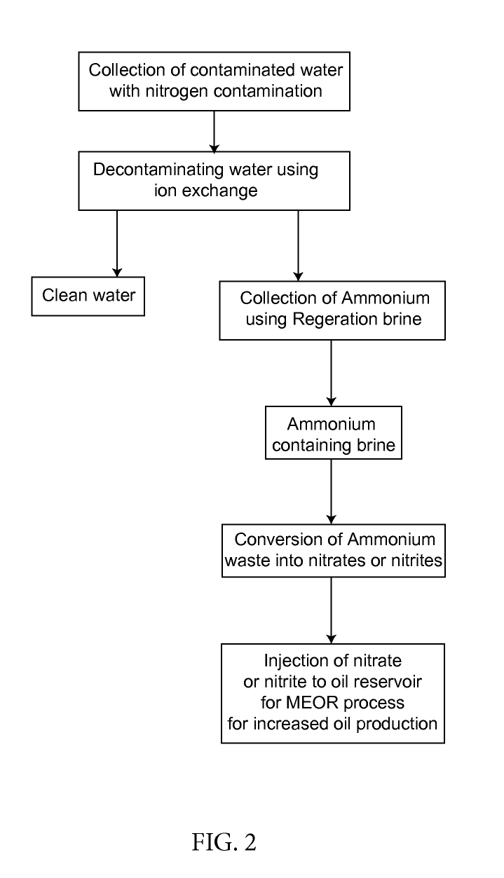

In reference to FIG. 2, when the nitrogen contaminant in the water is in the form of ammonium, the water can be filter by means of a cation exchange media. Although the practice of cation exchange removal of ammonia is only occasionally practiced, this is an option for the present invention for additional nitrogen feed. Cation exchange removal of ammonia is only occasionally practiced primarily due to the lack of used for ammonia in salt water and its cost for disposal. The cation exchange media include zeolites and cation exchange resins. The cation exchange media are then treated with a regeneration brine to remove the ammonium. The regeneration brine from the removal in nitrates from contaminated water can be reused as the regeneration brine for the cation resins from the removal of ammonium. Although ammonia may be decomposed to nitrates by natural oxidation and/or by microbial action, the preferred practice is to treat the ammonia to convert ammonium to nitrates which are then readily prepared for feeding of the microbes in MEOR. The highly nitrate concentrated brine can be taken directly from water contamination treatment facilities directly to oil recovery sites for application.

The reduction of the nitrogen waste in the form of nitrates, nitrites, and ammonium found in water bodies provides for safer drinking water. When consumed at high levels, the highly reactive nitrates and nitrites are toxic for humans. At high levels inside a human body, the nitrates and nitrites are able to enter the bloodstream. Inside the bloodstream, the nitrogen contaminants are able to react with hemoglobin. Hemoglobin is an important protein in blood cells that carries oxygen from the lung to all of the body parts and carbon dioxide from all of the body parts to the lung for exchange. When the nitrites enter the bloodstream, they react with the hemoglobin by oxidizing the iron atoms on the hemoglobin. The oxidation of the iron atoms prevents hemoglobin from being able to carry oxygen. With the accumulation of nitrates in the bloodstream, more and more hemoglobin is rendered unable to receive oxygen from the lungs. The lack of oxygen being supplied to the human's organs causes the human to suffocate.

In addition to safer drinking water, the reduction of nitrates, nitrites, and ammonium in water is beneficial for marine life as well. High levels of nitrates can inhibit growth, impair the immune system and cause stress to marine life. The nitrates that affect marine life originate from surface run off from agricultural or landscaped areas that receive nitrate fertilizer. The nitrates that reach the enclosed bodies of water accumulate and cause death to some of the local aquatic life. This can cause an imbalance to the local ecosystem.

The nitrates, nitrites and ammonium recovered from the contaminated waters are used to feed the microbes in MEOR. The microbes may be fed and bred outside of the oil well or fed while they are already inside the oil formation. MEOR is an in-situ flooding method under utilization specific microorganisms that are able to digest hydrocarbons or generate various products that enhance the oil recovery process. However, for the microbes to enhance the oil recovery process, they require nutrients that further improve their efficiency and productivity. The practice of using microbes to recover oil works more efficiently when the nutrients are added through mixtures are injected with the microbes into the oil production wells. The sole production of nitrates for the purpose of feeding the microbes in MEOR can be an expensive process. The expense of generating nutrients for the microbes is a major reason many oil recovery facilities avoid using microbial injection for enhanced oil recovery. However, by utilizing the nitrates extracted from contaminated waters to feed microbe, the cost is significantly reduced and makes MEOR a more cost effective method.

Microbial enhanced oil recovery is a tertiary oil extraction technology that provides partial recovery of residual oil of mature oil reservoirs. The goal of MEOR is to maximize recovery of oil entrapped in the porous media of a mature oil reservoir. MEOR is presently rarely used, due to recent developments of the field and the higher costs of operation. However, by introducing an affordable and convenient source of nutrients for the microbes used in MEOR, oil reservoir facilities are able to cut down on the operational costs of using MEOR.

Currently, one of the most commonly used enhanced oil recovery technique for tertiary oil extraction is gas injection. The gasses used in gas injection include carbon dioxide, natural gases, or nitrogen. The gas injection technologies rely on the displacement of oil due to the phase behavior of the oil and the injected gas. The phase behavior is also strongly dependent on the reservoir temperatures and pressure. The gas injection method is able to aid the recovery of trapped oils in porous media by reducing the viscosity of the crude oil. The reduction of the oil viscosity promotes the oil to flow more freely towards the low pressure space of the oil well. Another method that is currently used to improve oil recovery is chemical injections. This method of oil recovery involves the interaction of the chemicals with the oils to lower interfacial tension or capillary pressure that prevents oil droplets from flowing freely through the oil reservoir.

Compared to the gas injection and the oil recovery methods, MEOR provided with cheap nutrients is a financially friendly method of recovering oil and in some cases provide the same benefits of carbon dioxide oil recovery. Additionally, unlike chemical injection, the use of MEOR is an environmentally friendly method of oil recovery. The implementation of MEOR to existing field oil recovery facilities only requires minor modifications. The cost of the fluids for MEOR is independent of oil prices. These reasons make MEOR an excellent option as an enhanced oil recovery method. In addition to the economic benefits of utilizing MEOR with nitrates extracted from contaminated waters, MEOR is a very environmentally friendly oil recovery method. All of the products of MEOR are biodegradable and do not accumulate in the environment. The microbes used for MEOR originate and belong in the soil and the nitrates used are digested by the microbes. The microbes are able to digest the nitrates extracted from the contaminated water to generate biosurfactants. Other types of microbes can also emit carbon dioxide and allow the MEOR to function similarly as the gas injection method. The biosurfactants and/or the carbon dioxide are able to reduce surface tension and promote free flow of crude oils trapped in the porous media of an oil reservoir.

The present invention introduced is able to utilize the nitrogen waste extracted and collected from contaminated waters to be used as nutrients for the microbes used in microbial enhanced oil recovery. By using the method of the present invention offers many benefits. The removal of nitrogen waste from drinking water provides people with cleaner and safer water to drink. As a result, less people are susceptible to nitrate poisoning. The use of the nitrates extracted and collected from the contaminated waters as nutrients to feed microbes also prevents the nitrates from cycling back into ground water or surface waters. Without the nitrates flowing back into the ground waters or surface water, water bodies remain cleaner with lower contaminants. Additionally, the evaporation of water into the atmosphere contains lower nitrate concentrations and provides for cleaner air. The nitrates evaporate with the water into the air in the form of nitric acids that cause acidic rain. Acid rain can result in the acidification of other water bodies and damage trees or other building materials. The reduction of nitrates evaporating into the atmosphere also reduces the acidity of rain. The reduction of nitrates in the drinking water reintroduced back into the water sources reduces the overall contamination through mixing.

The use of nitrates collected from contaminated water for MEOR is financially beneficial as well. The removal of nitrates and other contaminants from contaminated water and the method of microbial injection for enhanced oil recovery can independently be very costly. The decontamination of contaminated water will require costs of contaminant removal. The regular disposal of contaminants results in the waste of nitrates that can be used for other purposes. Additionally, ecologically acceptable disposals of requires additional costs of preparation. The nitrogen waste collected from contaminated waters can all be readily converted to the nitrates and nitrites that microbes feed on. The microbial injection method of enhanced oil recovery can be costly when operated as an independent process as well. The nitrates can become a high cost item due to the need for large quantities. However, by combining the two processes, the expenses for disposal and manufacturing of nitrates can be eliminated. The nitrates collected from water decontamination can be directly processed and used as microbe feed in MEOR.

Although the invention has been explained in relation to its preferred embodiment, it is to be understood that many other possible modifications and variations can be made without departing from the spirit and scope of the invention as hereinafter claimed.

What is claimed is:

1. A Method for Using Nitrates Recovered from Contaminated Water for Feeding Microbes comprising the steps in combination of:
(a) collecting contaminated waters with nitrogen waste;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) injecting the injection fluid into an oil or gas well formation to improve production.

2. The method as claimed in claim 1 comprises,
wherein the nitrogen waste comprises nitrates, nitrites, and/or ammonium.

3. The method as claimed in claim 2 comprises,
wherein the ion exchange decontamination process includes the use of a anion exchange media or a cation exchange media.

4. The method as claimed in claim 3 comprises,
wherein the decontamination process is the removal of nitrates and nitrites by means of the ion exchange using anion exchange media; and
wherein the decontamination process is the removal of ammonium by means of the ion exchange using the cation exchange media

5. The method as claimed in claim 4 comprises,
wherein the nitrogen waste brine is produced by the removal of the nitrate wastes from the anion exchange media and the cation exchange media with a regeneration brine.

6. The method as claimed in claim 5 comprises,
wherein the regeneration brine is a predominately chloride brine.

7. The method in claim 6 comprises,
wherein the regeneration brine is from an oil well or natural gas well

8. The method in claim 6 comprises,
wherein the regeneration brine is from a water purification process.

9. The method in claim 6 comprises,
wherein the regeneration brine is from water used in growing halophytes and/or salt tolerant algae.

10. The method in claim 6 comprises,
wherein the regeneration brine produced along with the oil using MEOR and with reduced content of nitrate and nitrites is reused as the regeneration brine for removal of nitrogen contamination from ion exchange media.

11. The method as claimed in claim 1 comprises,
wherein the contaminated water is collected from a drinking water source.

12. A Method for Using Nitrates Recovered from Contaminated Water for Feeding Microbes comprising the steps in combination of:
(a) collecting contaminated waters with nitrogen waste;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) injecting the injection fluid into an oil or gas well formation to improve production.

13. The method as claimed in claim 12 comprises,
wherein the nitrogen waste comprises nitrates or nitrites; and
wherein the ion exchange decontamination process includes the use of a anion exchange media.

14. The method as claimed in claim 13 comprises,
wherein the decontamination process is the removal of nitrates and nitrites by means of the ion exchange using anion exchange media;
wherein the nitrogen waste brine is produced by the removal of the nitrate wastes from the anion exchange media.

15. The method as claimed in claim 12 comprises,
wherein the contaminated water is collected from a drinking water source.

16. A Method for Using Nitrates Recovered from Contaminated Water for Feeding Microbes comprising the steps in combination of:
(a) collecting contaminated waters with nitrogen waste, wherein the contaminated water is collected from a drinking water source;
(b) decontamination processing of the contaminated waters by means of ion exchange, wherein the decontamination process produces a nitrogen waste brine having increased concentration of nitrogen waste and a decontaminated water with decreased concentration of nitrogen waste;
(c) processing of nitrogen waste brine to produce a nitrogen feed mixture; and
(d) injecting the injection fluid into an oil or gas well formation to improve production.

17. The method as claimed in claim 16 comprises,
wherein the nitrogen waste comprises nitrates, nitrites, or ammonium; and
wherein the ion exchange decontamination process includes the use of a anion exchange media or a cation exchange media.

18. The method as claimed in claim 17 comprises,
wherein the decontamination process is the removal of nitrates and nitrites by means of the ion exchange using anion exchange media;
wherein the decontamination process is the removal of ammonium by means of the ion exchange using the cation exchange media; and
wherein the nitrogen waste brine is produced by the removal of the nitrate wastes from the anion exchange media and the cation exchange media with a regeneration brine.
